(19) United States
(12) Patent Application Publication
(10) Pub. No.: US 2009/0019525 A1
(43) Pub. Date: Jan. 15, 2009

(54) DOMAIN-SPECIFIC LANGUAGE ABSTRACTIONS FOR SECURE SERVER-SIDE SCRIPTING

(76) Inventors: Dachuan Yu, Foster City, CA (US); Ajay Chander, San Francisco, CA (US); Hiroshi Inamura, Cupertino, CA (US); Igor Serikov, Fremont, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/163,848

(22) Filed: Jun. 27, 2008

Related U.S. Application Data
(60) Provisional application No. 60/949,568, filed on Jul. 13, 2007.

(51) Int. Cl. G06F 21/00; G06F 9/45; H04L 9/32

(52) U.S. Cl. 726/3; 717/104; 726/26

(57) ABSTRACT

A method and apparatus is disclosed herein for secure server-side programming. In one embodiment, the method comprises creating a server-side program with one or more abstractions and compiling the server-side program by translating the server-side program, including the one or more abstractions, into target code that is guaranteed to execute in a secure manner with respect to a security criteria.

### PRIORITY

The present patent application claims priority to and incorporates by reference the corresponding provisional patent application Ser. No. 60/949,568, titled, “Domain-Specific Language Abstractions for Secure Server-Side Scripting,” filed on Jul. 13, 2007.

### FIELD OF THE INVENTION

The present invention relates to the field of server-side programming; more particularly, embodiments of the present invention are related to the field of writing secure server-side programs for interactive web applications.

### BACKGROUND OF THE INVENTION

A key component of web-based applications is the programs running on the web servers. These server-side programs (referred to as “server programs” for purposes herein) take client input in the form of HTTP requests, perform computation and enforce the business logic of the applications, and produce output for the client in the form of HTML pages.

With the growing popularity of web applications, especially those which manage sensitive data and perform critical functionalities (e.g., online banking), the security of the server programs has become a major concern. Indeed, web applications face several more security threats than conventional desktop applications. Some representative ones include command injection, cross-site scripting (XSS), cross-site request forgery (CSRF), and session fixation, which are described in more detail below. Any of these could cause serious consequences: sensitive user information could be stolen, data and associated belongings could be damaged, or service availability could be compromised.

In response to such security threats, existing languages and frameworks for server-side scripting, as well as the web application security community, largely promote secure coding practices (e.g., input validation) and provide helpful library functions in support (e.g., filtering functions). However, there is no guarantee that programmers will follow the recommendations correctly, if they followed them at all. Furthermore, even if all programs are written with the security practices strictly enforced, the extra care that programmers spend on preventing vulnerabilities would distract from the intended business functionalities. Take the implementation of an online payment as an example. To securely code a web interaction of “obtaining the payment details,” one must correctly perform input validation, maintain program states across the interaction, and prevent request forgery. These operations are described below in conjunction with an example.

### An Ideal View

A simple online-banking example is used to demonstrate what is involved in writing secure server programs. This application provides two main services: showing account balances (the “balance” service) and setting up payments (the “payment” service). To access the services, a user must first log into her account.

Although serving multiple users, this web application logically deals with one client at a time. In an ideal view, there are multiple orthogonal instances of the server program running, each taking care of a single client. Every single instance of the program can be viewed as a sequential program of a conventional application. A work flow graph following this ideal view is shown in FIG. 1A.

### A Limited Mechanism

The above ideal view cannot be directly implemented, because of some limitations of the underlying HTTP mechanism for web interactions. In particular, there is no persistent channel for a server program to obtain input from a client. Instead, HTTP supports a one-shot request-response model where a client requests some resources identified by a URL, and a server responds with the resources if the request is accepted. Using HTTP, web interactions are typically carried out as a sequence of requests (form submissions) and responses (web pages), where the requests provide user input, and the responses present information to the user:
HTTP 0→HTML 0→HTTP 1→HTML 1→HTTP 2→HTML 2 . . .

Using this model, a server program is often split into multiple fragments. Each fragment takes an HTTP request and produces an HTML response. In the response, there can be a web form with an embedded URL pointing to the next fragment, so that the next request is targeted correctly. Therefore, the server work flow of our banking application is more accurately described as in FIG. 1B. Four program fragments are now involved. They are connected with proper URL embeddings, as indicated by the dashed lines. In particular, because the payment service requires user input, the structure of the service loop in the ideal view can no longer be coded as an explicit loop. Instead, a goto-style structure is exhibited through URL embeddings. Such fragmentation and low-level control structures obscure the control flow of the server program.

Besides obscurity, there is a bigger issue: HTTP is stateless, therefore server programs must maintain program states on their own. In the example, the user name obtained from the login input must be saved and restored explicitly across the later web interactions. In addition, the server programs must somehow correlate incoming requests with specific clients, since multiple clients may be interacting with the server at the same time, although in logically separate transactions.

In practice, a web application needs to encode states at a level above HTTP. There are several alternatives applicable to different situations. Typically, a virtual concept of “a session” is used to refer to a logical transaction. Every session is associated with a unique ID, called SID. Saved program states and incoming client requests are both identified by the SID.

As a result, much code in server programs is dedicated for manipulating sessions. Before generating a response, a server program must save state and embed the SID in the response. Upon receiving a request, the server program must obtain an SID from the request and load state. Based on the applications, some parts of the state should be saved on the server, whereas others should be on the client via cookies or URL embedding. These routine manipulations increase the complexity of server programs, reduce productivity, and extend the chances of programming errors.

### A Dangerous World

Assuming a programmer has taken care of all the above issues correctly, the resulting program may still not be ready for deployment. The problem is security: clients in the real world may be malicious, or attackers may trick innocent clients into making mistakes.

Indeed, there have been many common web security vulnerabilities identified. Secure programming solutions have been proposed accordingly. Nonetheless, a programmer must be aware of all the issues involved and implement the related defenses. Most of these defenses are orthogonal to the business logic of specific web applications.

In what follows, a brief overview of some representative security issues is given. The goal is to demonstrate the complexity of web programming, rather than to give a comprehensive list. These security issues include CSRF, XSS, session fixation, along with others.

CSRF—An attacker may forge a request as if it was intended by another user, without the user being aware of it. This is mainly applicable when SIDs are stored in cookies. Suppose the banking example above is not coded securely. Such an attack could be launched if a user, while logged in, opens a malicious email containing a crafted image link. Trying to load the image, the user's browser may follow the link and send a request to the banking server asking for a payment to be set up to the attacker. A typical defense is to embed some secret tokens in URLs to critical functionalities; a forged request would not have the token, thus will not be processed on the server side.

XSS—An attacker may inject malicious code into the HTML page that the server program sends to a victim user. In one typical scenario, an attacker sends to a victim a crafted link with malicious JavaScript code embedded; when the victim loads the link, a vulnerable server program may propagate the embedded code into the HTML response. The malicious code, now coming from the server, gains the privilege of the server domain. For example, it may read the cookie set by the server and send it to the attacker. This scenario is somewhat related to CSRF. However, there are also second-order attacks that do not require the use of forged requests. A typical defense is to filter web input before processing it.

Session fixation—An attacker may fix an SID beforehand and trick the user into communicating with the server using that fixed SID. This is mainly applicable if SIDs are embedded in URLs. An innocent user may click on a link in a malicious email which claims to be from our banking site. The link takes the user to the banking site described herein, but using an SID fixed by an attacker. If the same SID is used by our server programs for later web interactions after the user logs in, the attacker's knowledge of the SID will gain her full privileges of the user. A typical defense is to regenerate the SID when a privilege changes (e.g., upon a successful login check).

Others—There are many other aspects that affect security. Consider the fact that a web application is implemented as multiple program fragments. Each fragment is open as a service interface. An attacker could make up requests to these interfaces without strictly following the links provided in the server responses. Using the crafted requests, they could potentially poison program states (e.g., by modifying naive implementations of client-side states), inject malformed input (e.g., by exploiting insufficient input validation), or circumvent intended work flows (e.g., by unexpected use of the “back” button).

Programmers need to be aware of all these issues and follow the relevant security practices. In the result code, business logic is intertwined with security manipulations. Consequently, secure web programming is difficult, and web programs are hard to maintain. In the area of declarative web programming, domain-specific language constructs have been used to program web applications. In such a case web applications are viewed as form-based services, and abstractions are provided on some key aspects such as web input and state management. These abstractions hide implementation details (e.g., input validation, embedding of continuation and state in URL), thus preventing certain programming errors. They also help to separate the control flow (business logic) from the user interface (HTML pages). However, the prior art does not provide any formal semantics with security guarantees. Nonetheless, security cannot be overlooked for declarative web programming—now that web interaction details are hidden by new abstractions, programmers can no longer carry out the secure coding practices by themselves. As a result, a naive application of new abstractions could suffer from security vulnerabilities such as session fixation and CSRF.

There has also been work developing domain-specific languages or frameworks for web programming as libraries of existing type-safe languages. Some notable examples are the Curry-based server-side scripting language, the Haskell-based WASH/CGI, and the Smalltalk-based Sea-side. These provide useful abstractions in the form of libraries to handle some common aspects of web programming, such as structured HTML generation, session management, and client-server communication. However, they do not provide all the formal security guarantees described herein. Furthermore, there is no stand-alone formal semantics for the new abstractions, although in principle the exact behaviors could be inferred from the implementations and the semantics of the host languages. Finally, they are tied to the host languages, and thus the ideas are not easily applicable to other languages.

### Models of Web Programs

It is also important to understand what the existing web programming model is and how to write secure programs within it. Although there are many security recommendations and coding practices available on the topic, web programming has rarely been formally studied from the language principles. In one exception, web interactions are modeled in the presence of whimsical navigation behaviors of well-intended (non-malicious) users, two classes of errors (form field mismatch, client-server state mismatch) are identified, and it is proposed to catch the errors with a static type system (typed web forms) and dynamic checks (time-stamped states). This exception does not address the wider security questions, where there are multiple clients interacting with a server, and some of the clients may be malicious. To be specific, it does not have security-related primitives in the server-side computation, it models web programs in the presence of a single client, and the transitions lack the counterpart of some forging and tricking behaviors described herein.

### SUMMARY OF THE INVENTION

A method and apparatus is disclosed herein for secure server-side programming. In one embodiment, the method comprises creating a server-side program with one or more abstractions and compiling the server-side program by translating the server-side program, including the one or more abstractions, into target code that is guaranteed to execute in a secure manner with respect to a security criteria.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1A illustrates idealistic work flow of online banking.

FIG. 1B illustrates actual work flow of online banking.

FIG. 2 illustrates is a flow diagram of one embodiment of a process for server side scripting.

FIG. 3 illustrates simple banking in BASS.

FIG. 4 illustrates a virtual view of the execution environment.

FIG. 5 illustrates BASS syntax.

FIG. 6 illustrates BASS operational semantics.

FIG. 7 illustrates BASS typing rules.

FIG. 8 illustrates a model of web programming.

FIG. 9 illustrates MOSS syntax.

FIG. 10 illustrates MOSS expression evaluation.

FIG. 11 illustrates MOSS world execution: part 1/2.

FIG. 12 illustrates MOSS world execution: part 2/2.

FIG. 13 illustrates translation.

FIG. 14 is a block diagram of an exemplary computer system.

### DETAILED DESCRIPTION OF THE PRESENT INVENTION

Embodiments of the present invention are related to the field of writing secure server-side programs for interactive web applications. Web applications reflect a different computation model than conventional software, and the security issues therein deserve careful study from both language principles and practical implementations. The techniques described herein help building a formal foundation for secure server-side scripting. In particular, two self-contained formalizations on the topic are described.

The first is a declarative language, BASS, for server-side scripting. BASS provides a programming model where the server interacts with a single client, using some dedicated constructs to obtain web input and manipulate client history. The meta properties and formal guarantees of BASS allow programmers to focus on the application logic without being distracted by common implementation details, thus improving productivity and security.

The second is a model, MOSS, characterizing realistic web programming concepts. MOSS can be used to write secure programs as well as vulnerable ones. A formal translation from BASS to MOSS is presented, demonstrating how the BASS abstractions and security guarantees can be enforced in practice using a few common primitives for manipulating security concepts.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc. The Web of today is commonly used as a platform for hosting sophisticated applications and services.

### Overview

As described above, it is notoriously difficult to program a solid web application. Besides addressing web interactions, state maintenance, and whimsical user navigation behaviors, programmers must also avoid a mine-field of security vulnerabilities. The problem is fundamentally twofold. On the one hand, there is a lack of a solid understanding of the essence of the new computation model underlying web applications. On the other hand, there is a lack of proper abstractions for hiding common and subtle coding details that are orthogonal to the business functionalities of specific web applications.

Both issues are addressed herein. First, a high-level language BASS is presented for declarative server-side scripting. BASS allows programmers to work in an ideal world, using some new abstractions to tackle common but problematic aspects of web programming. The formal semantics and meta properties of BASS provide useful security guarantees. Second, a low-level language MOSS is presented whose formal semantics reflects realistic web programming concepts and scenarios, thus articulating the computation model behind web programming. Finally, a rigorous translation from BASS to MOSS is presented, demonstrating how the ideal programming model and security guarantees of BASS can be implemented and enforced in practice.

Observing that many of the security issues are orthogonal to the specific business logics of the web applications, some new abstractions for writing secure server programs are disclosed herein. These abstractions provide an ideal view of some key aspects of web programming (e.g., “to obtain a number from the client”), and hide the common security handlings (e.g., input validation, session state maintenance, and prevention of request forgery).

Using these abstractions, a language for server-side scripting can be given a high-level syntax and semantics that reflect useful and secure web operations, with the correct enforcement of the semantics taken care of by the underlying language implementation following established security practices once and for all. As a result, all programs written in the language, although not directly dealing with low-level security constructs, are guaranteed to be free of certain security vulnerabilities. In addition, in terms of the high-level semantics, programmers can focus more on business logics, which results in better security and higher productivity. To some extent, the new abstractions hide security details in the same way as object creation primitives in object-oriented languages hide low-level memory management details.

To demonstrate how the disclosed abstractions can be correctly implemented, the low-level language MOSS (as in “a model of server-side scripting”) reflects the programming model of existing languages for server-side scripting. MOSS is of independent interest, because it articulates typical client and server behaviors, including both well-behaved client requests and malicious attacker exploits. BASS is translated into MOSS, where the ideal model of BASS is enforced with the help of proper MOSS primitives for manipulating security concepts. How the security guarantees of BASS are maintained is also explained.

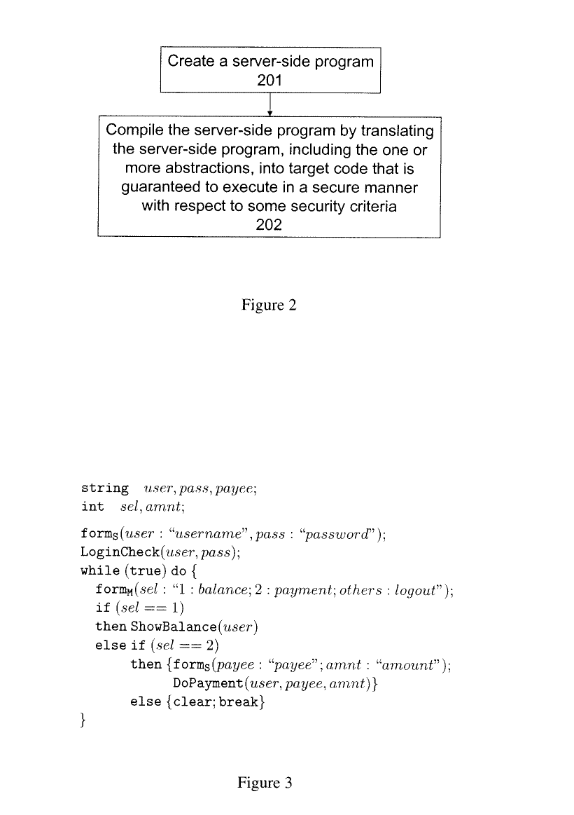

FIG. 2 is a flow diagram of one embodiment of a process for server-side scripting. The process is performed by processing logic that may comprise hardware (e.g., circuitry, dedicated logic), software (such as is run on a general purpose computer system or a dedicated machine), or a combination of both.

Referring to FIG. 2, the process begins by processing logic creating a server-side program (e.g., a web program) with one or more abstractions (processing block 201). In one embodiment, abstractions comprise at least one domain-specific abstraction. In one embodiment, the abstractions comprise one or more abstractions from a group consisting of a web input abstraction, a session management abstraction, a state maintenance abstraction, and an exploit prevention abstraction. In one embodiment, the abstractions comprise at least one script.

In one embodiment, the web input abstraction comprises a form construct that implicitly opens a service interface for receiving user requests. In one embodiment, the form construct specifies a single-use mode in which the service interface is open only once before an error is generated or a multi-use mode in which the service interface remains open for future requests. In one embodiment, the form construct takes an HTML document as an argument. In one embodiment, the form construct presents an HTML page to a client and obtains input from the client in response thereto.

In one embodiment, the abstractions comprise a clear command to cause a client state to be removed. In one embodiment, the client state comprises client history.

In one embodiment, the server-side program is a web program and the one or more abstractions comprise a set of abstractions on web input, session management, state maintenance, and exploit prevention.

In one embodiment, creating a server-side program comprises inserting the one or more abstractions into a preexisting server program.

After creating the server-side program, processing logic compiles the server-side program by translating the server-side program, including the one or more abstractions, into target code that is guaranteed to execute in a secure manner with respect to some security criteria (processing block 202). In one embodiment, compiling the server-side program comprises inserting security checks to enforce semantics of the security criteria during compilation. In one embodiment, compiling the server-side program comprises adding one or more primitives to cause one or more client-side states to be removed.

The embodiments of the present invention program web applications using a high-level language that handles some common security aspects behind the scene. This language benefits from new abstractions designed for web programming. A program in this language more directly reflects the business logic of the target application, and therefore is easier to write, to reason about, and to maintain. The language implementation (the compiler) will generate secure target code following established security practices.

### Abstracting Web Interactions

From discussions above, much of the complication is due to the need of obtaining user input. Therefore, supporting web interactions is a key. Embodiments of the present invention use a dedicated construct form for this purpose.
form(p: “username”,q: “password”);
   The intention of the form construct is to present an HTML page to the client and obtain some input. In a realistic deployment, such a construct would take as argument a full-fledged HTML document, possibly generated dynamically and/or containing multiple component forms. In order not to obscure the present invention, the form construct takes arguments to describe input parameters of a single web form. In the above example, the form construct presents to the client a simple form comprised of two fields: username and password. After the client fills in the form and submits it, the form construct assigns the values provided in the fields to the two variables p and q.

There are a few issues handled implicitly by the underlying implementation. First, the server program is split upon a form construct, and proper URL embedding is used in the web page to connect the control flow. Second, the input values of the variables are parsed from the form submission, and input validation is performed according to the declared variable types. Third, it follows standard security practices to manage sessions, maintain states, and defend against common exploits. Details of an implementation will be discussed in more detail below. For now, it suffices to understand this construct from a programmer's point of view as an abstract and secure web input operation which does not break the control flow.

### Supporting User Navigation

In one embodiment, such a form construct implicitly opens up a service interface that can receive user requests. There would be vulnerabilities if it were not handled properly, or if its handling were not sufficiently understood by the programmer. Prior art approaches on web interaction abstractions require that the interface be “open” only once—a second request to the interface would not be accepted. This significantly restricts user navigation. In practice, it is common for a user to return to a previous navigation stage using the “back” button. In general, any item in the browser history could be revisited by the user. The validity of such an operation should be determined by the application, rather than be dismissed all together. For the given banking example, it is reasonable to allow a user to duplicate the service selection page and proceed with both “balance” and “payment” in parallel.

For this purpose, in some embodiments of the present invention, two modes of web interactions are allowed: a single-use mode (form_{S}) and a multi-use mode (form_{M}). In the single-use mode, the interface is open for request only once; revisiting the interface (e.g., by activating a browser bookmark) results in an error. In the multi-use mode, the interface remains open for future requests. The semantics of BASS articulates the program behavior in both cases; therefore, the programmer can choose the suitable one based on the application. In either case, a request is accepted only if it follows the intended control flow of the server program to the interface. Consider the given banking example. It is okay if the user reached the service selection page, bookmarked it, and reused it before logging out. However, it is not okay if the user forged a payment request without going through the login and service selection pages first.

### Maintaining Program States

Multi-use forms are sufficient to accommodate all possible client navigation behaviors, because any behavior can be viewed as revisiting a point in the browser history. From a programmer's point of view, the program is virtually forked into multiple parallel “threads” at a multi-use form statement, together with all appropriate program state. The handling of the program state there is nontrivial. Some parts of the state could be local to the individual threads, whereas others could be global to all threads. The “local” state of a thread will not be affected by other threads, whereas the “global” state may be affected by others. Careless treatment of the state may result in logical errors.

The exact partitioning of the state should be determined by the application. In one embodiment, programmers are allowed to declare variables as either volatile or nonvolatile. For example, volatile state can be stored in a database on the server across web interactions, thus all forked threads refer to the same volatile state. In contrast, nonvolatile state (after proper protection against client modifications) can be embedded in the URLs of web forms upon web interactions, thus every forked thread has its own nonvolatile state.

### Manipulating Client History

Sometimes it is useful to disable some previously forked threads. Suppose the user tries to reload the service selection page after logging out of the banking application described above. The server program will receive a request that should not be processed. In one embodiment, a mechanism is included to disable some of the entries in the client history. In existing web applications, this is sometimes handled by embedding special tokens into web forms and checking them upon requests. Upon logging out, the server program expires the corresponding token, and thus further requests to the service selection page will no longer be processed.

To avoid exposing the details of token embedding to the programmer, a simple clear command is used for a similar purpose. From the programmer's point of view, clear simply resets the client history, so that all previously forked threads are discarded. This corresponds to the “session timeout” behaviors of many web applications. However, instead of thinking in terms of disabling the token of SID, BASS encourages programmers to think in terms of the client history. There are certainly more general ways to manipulate the client history. One possibility is to attach a privilege level to every web form, and to manipulate the forked threads by levels. Note that such level management can easily be implemented by the programmer using the provided abstractions of web input, volatile state, and nonvolatile state. More specifically, the current level can be stored in a volatile variable on the server as the global level. Upon a web interaction, the current level can be attached to the current thread using a nonvolatile variable as the local level. Comparison on the global and local levels and proper handlings can be done upon any user requests. Although not increasing the expressiveness of the language, abstractions for the level-based privilege management may prove convenient for certain applications. However, since its handling is straightforward, it has been omitted and the simple clear command is used for demonstration.

### Example Revisited

The appeal of the above introduced abstractions are demonstrated by revisiting the banking example as implemented in FIG. 3.

Using the new abstractions, the programmer works with an ideal world where there is only one client and the client is well behaved. Referring to FIG. 3, the code obtains the login information from the client, performs login check (LoginCheck terminates the program if the check fails), and proceeds with a service loop. Based on the service selection of the client, the code in the service loop carries out the balance service (ShowBalance) or the payment service (DoPayment), or logs the user out. The service selection input is coded using a multi-use form, therefore the user may duplicate the corresponding web page and proceed with the two services in parallel. In addition, clear is used to disable all service threads when the user logs out. In this example, only the user variable is live across web interactions. Its value is obtained from a single-use form, and will not be updated after the login process. Therefore, it can be declared as either volatile or nonvolatile.

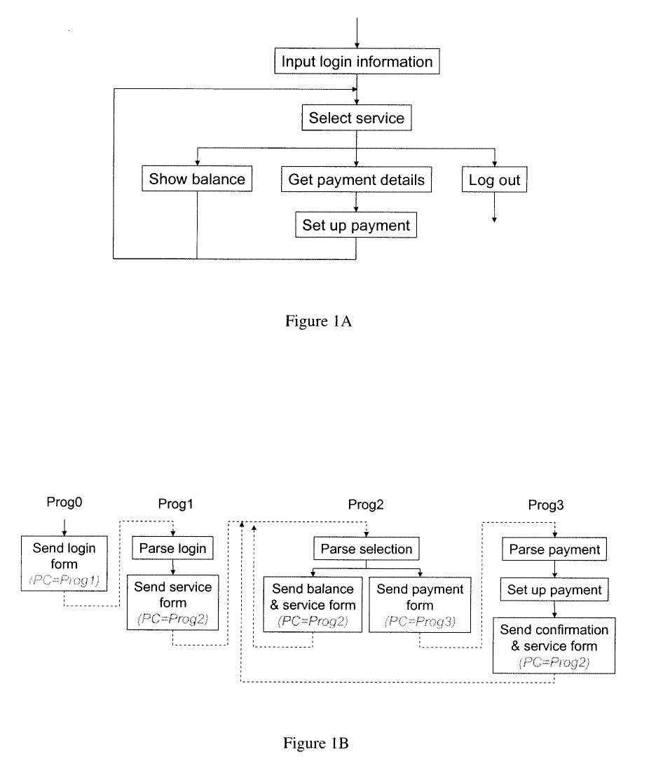

This code corresponds well with the work flow of FIG. 1, and is much cleaner than a version directly written in an existing language. More importantly, it does not sacrifice security, because the implementation of the new abstractions will take care of the “plumbings” transparently—it will split the program into multiple fragments, maintain program states across web interactions, filter input based on variable types, and carry out relevant security manipulations such as the embedding of secret tokens.

Of course, these abstractions may not be suitable for all programming tasks. For applications that require little dynamic manipulation and state maintenance, it may not be as big a burden to directly code the security details. However, observing the growing popularity and complexity of web applications, especially in critical areas, such abstractions will bring many benefits.

### BASS

The above ideas are formalized in a high-level language BASS. BASS provides a declarative view for programmers to write secure programs without worrying about the low-level details described above. The meta-properties of BASS provide useful security guarantees. Assuming the semantics is enforced correctly by an underlying implementation, all well-formed BASS programs will be secure in a certain sense. For example, values obtained from web input will always have the expected types, forged requests from attackers will be rejected, and the control flow of the program will be enforced. These properties will be articulated in more detail below after the BASS syntax and semantics.

### Syntax

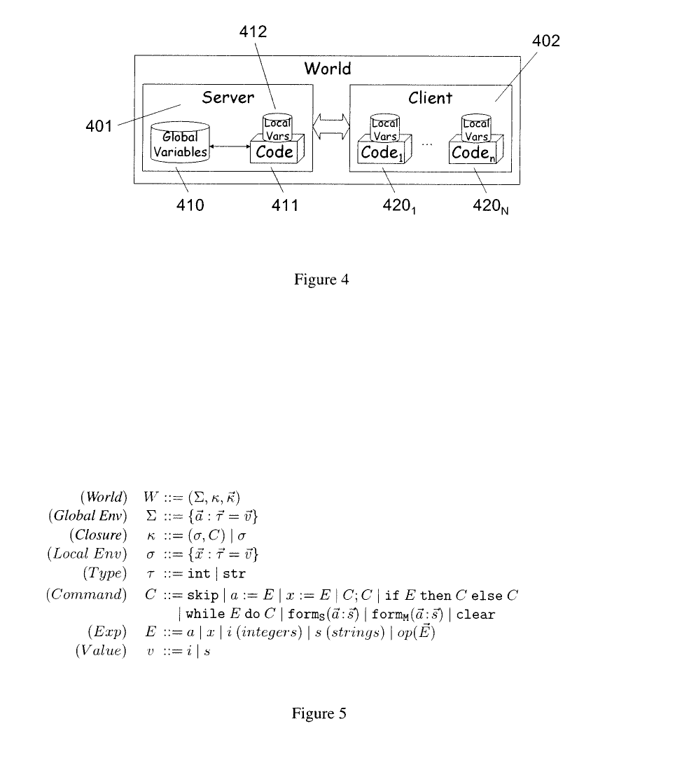

A graphical depiction of the virtual execution environment of BASS is given in FIG. 4. The word “virtual” is used because the view does not dictate how BASS is implemented; it simply provides a tractable world for the programmer to deal with.

Referring to FIG. 4, in this world, there is a single server 401 and a single client 402. Server 401 consists of a global environment for volatile variables 410 and a closure of the current execution. The closure is made up of a local environment for nonvolatile variables 412 and some code 411. During execution, server 401 executes the code with respect to the two variable environments, global variables 410 and local variables 412. Upon a web interaction, server 401 sends a proper closure to client 402, and client 402 is then activated.

Client 402 simply involves a list of closures. These closures reflect the browsing history of client 402. When client 402 is active, it chooses an arbitrary closure in the browsing history, fills in the corresponding web form, and sends the result to server 401. Although many code pieces appear in the list of closures on the client side, they would actually be realized as program pointers embedded in the forms in an underlying implementation. Similarly, the local environments can also be realized in forms.

FIG. 5 illustrates one embodiment of the BASS syntax. The vector notation \vec{κ} is used to refer to the list of [κ₁ . . . κₙ]. Similar notations are also used for other meta variables.

Referring to FIG. 5, a complete world is a 3-tuple (Σ,κ,\vec{κ}). The first element Σ is the global variable environment, which is essentially a mapping from volatile variables to their types and values. The second element κ is the closure currently active on the server. The third element \vec{κ} is the client browsing history.

A closure is usually a pair of a local environment and a command. Sometimes, an environment without a command also makes a closure; such a closure cannot be executed, but the information therein may be propagated to other closures. The local environment is a mapping from nonvolatile variables to types and values. It is assumed that the names of volatile and nonvolatile variables are disjoint. In one embodiment, by convention, the following a,a′,a₁, . . . are used for volatile variables, and x,x′,x₁, . . . for nonvolatile variables. In one embodiment, only two types are used: integer (int) and string (str). Booleans are simulated with integers.

Commands are common except for web interactions (form_{S}, form_{M}) and history clearing (clear) as described above. For simplicity, web forms only input volatile variables; this does not affect expressiveness, because the input values can be passed on to nonvolatile variables with assignments. Expressions and values are as expected. The notation op is used to abstract over all operations free from side-effects, such as string concatenation and comparison. Function calls are standard and introduce no new issues; it is omitted for conciseness.

### Operational Semantics

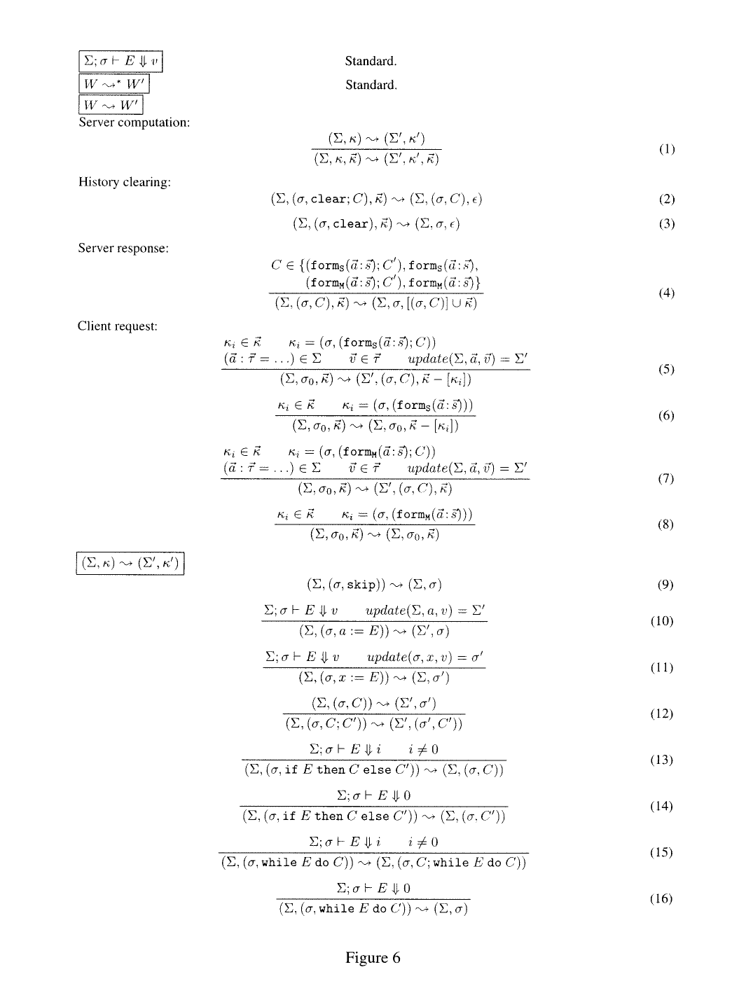

In one embodiment, big-step semantics is used for expressions. Details are standard and thus omitted. FIG. 6 illustrates one embodiment of the execution of a world in a small-step style. In other words, the BASS operational semantics is presented. The notation used in FIG. 6 would be understood to those skilled in the art. The key concept is a “world step” relation W [symbol] W′. There is a multi-step relation W [symbol] W′ defined as the reflexive and transitive closure of the world step relation.

In world step, some rules reflect server-side computation, whereas others reflect client-side input. Rule (1) describes a server computation step by referring to a single-thread step relation (Σ,κ) [symbol] (Σ′,κ′). This is applicable only when the current command starts with skip, assignment, conditional, or loop (the single-thread step relation is undefined on other cases). If the current command is clear, Rules (2) and (3) apply to remove all closures from the client side. In these rules and the remainder of this report, the notation ε is used to denote the empty vector. Upon any form commands, Rule (4) applies to transfer the closure to the client side. The notation [κ] ∪ \vec{κ} means to combine the singleton vector [κ] with \vec{κ}.

Client input through a single-use form is captured in Rules (5) and (6). Note that in one embodiment there is no further command to execute on the server, therefore the client takes control. In Rule (5), the client selects the closure κᵢ to proceed next. This corresponds to picking an arbitrary point in the browsing history. The client may input arbitrary values to the form, as long as they are of the right types (\vec{v} ε \vec{τ}). Based on the input values, the global environment is updated using the macro update (Σ,\vec{a},\vec{v}), which updates Σ so that the variables \vec{a} will have the values \vec{v}. As a the result of the step, the global environment is updated, and the chosen client closure is moved to the server for execution. The notation \vec{κ}−[κᵢ] means to remove κᵢ from \vec{κ}. As a trivial variant of Rule (5), Rule (6) describes the case where there is no further command in the chosen closure to execute after the form input. In this case, the chosen closure is simply removed from the client.

Rules (7) and (8) are for client input through multi-use forms. The difference in comparison with the single-use ones lies in the result browsing history. For single-use forms, the selected closure is removed from the history so that it cannot be revisited. For multi-use forms, the browsing history remains the same. All the client request rules are non-deterministic on closure selection. It is possible for a client to “abandon” a closure by never selecting it.

The single-thread step relation is straightforwardly described in Rules (9)-(16). Here the macro update is overloaded to update both the global and the local environments.

### Typing Rules

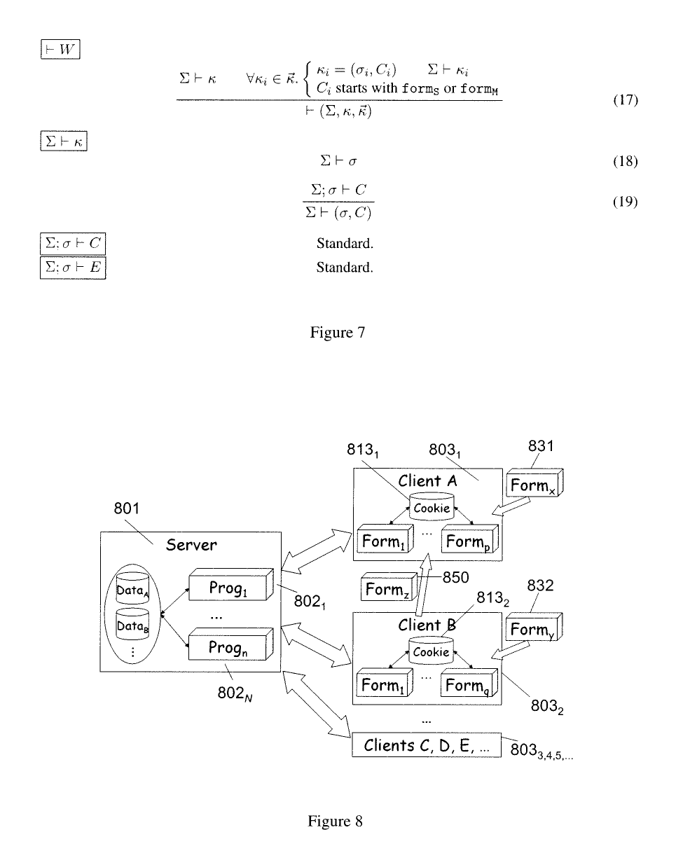

FIG. 7 illustrates some non-standard typing rules for use in one embodiment. In Rule (17), a world (Σ,κ,\vec{κ}) is well-formed if all closures (κ and \vec{κ}) are well-formed with respect to the global environment (Σ), and every closure (κᵢ) on the client side contains code which starts with a web form. The well-formedness of closures is defined in Rules (18) and (19). A trivial closure σ is always well-formed. A nontrivial closure (σ,C) is well-formed with respect to Σ if C is well-formed with respect to Σ and σ. The standard handling on the well-formedness of commands and expressions has been omitted, where types of variables are pulled from the corresponding environments.

### Meta Properties

BASS enjoys standard type soundness via preservation and progress.
Lemma 1 (Prevervation) If ├ W and W [symbol] W′, then ├W′.
Lemma 2 (Progress) If ├ W then either there exists W′ such that W [symbol] W′, or W is of the form (Σ,σ,c).

These lemmas imply that well-formed programs will execute until termination without getting stuck (getting into a state where no further step can be made according to the operational semantics). Although seemingly uninteresting, this indeed provides useful guarantees for server-side scripting. It essentially guarantees that the program execution will be confined by the operational semantics—only the transitions defined by the operational semantics may occur. Therefore, all behaviors reflected by the operational semantics are guaranteed. For example, in one embodiment, such behaviors include:
1. The control flow will follow the explicit high-level structures;
2. Values obtained from web input will be well typed;
3. Program states will be kept intact across web interactions;
4. Entries in the client history will be disabled upon clear;
5. There will be only one client interacting with the program instance.

With these guarantees, in one embodiment, the programmer no longer needs to worry about certain common low-level maneuvers, such as:
1. Embedding and enforcing of the control flow;
2. Validating the names and types of web input parameters;
3. Recovering program states across web interactions;
4. Addressing unexpected user navigation behaviors;
5. Protecting against malicious exploits that involve multiple clients (e.g., CSRF, first-order XSS, and session fixation).

In one embodiment, BASS provides a high-level view of web programming, with certain desirable properties guaranteed directly by the semantics. All well-formed programs in BASS enjoy those properties, thus the programmer gains improved productivity and common security protections. More specifically on security, the BASS semantics leaves no room for CSRF, first-order XSS, session fixation, session poisoning, ill-typed input, and work-flow circumvention. Of course, the operational semantics must be properly enforced by an underlying implementation. This is the topic of the next two subsections, where MOSS is formalized following a realistic web programming model, and BASS is translated into MOSS in such a way that the BASS operational semantics is faithfully carried out.

### MOSS

The following presents a formal model of web programming, articulating server-side program execution and client-side behaviors. This model reflects realistic web interactions, and can be used to illustrate both well-behaved client/server activities and malicious exploits. This model is used mainly as a rigorous compilation target to demonstrate how the BASS abstractions can be realized. Nonetheless, it is also of independent value to other studies on web programming. We will explain how concepts in this model correspond to real-world entities throughout the section.

### Syntax

FIG. 8 illustrates a graphical depiction of a model of web programming. On the side of server 801, there are a group of programs 802₁-802_{N} collaborating to implement the desired application logic. They access and update data that belong to multiple web clients. Server 801 interacts with multiple clients 803₁,803₂,803₃ . . . simultaneously, although in separate logical transactions. Every client has its own cookie (e.g., 813₁, 813₂, etc.), and maintains a list of forms as the browsing history. Although forms are expected to be obtained from the server side through web interactions, a client may also forge a form on its own (as illustrated using Formₓ 831 and Form_{y} 832, which appear to come from nowhere). This reflects real-world exploits where a client makes up an HTTP request without going through the intended application logic. In addition, a malicious client 803₂ may trick an innocent client 803₁ by inserting a form 850 from the history of client 803₂ (part of which may be forged) into the history of client 803₁ (as illustrated using Form_{z} 850). In the real-world counterpart, an attacker may send crafted links to a victim in an email; sometimes, these links are image links that may he automatically loaded by a browser.

Whereas the virtual execution environment of FIG. 4 provides an ideal view for the programmer to work with, the model here reflects real-world web application scenarios, where the server programs interact with and maintain data for multiple clients. In addition, the clients are no longer always well-behaved. To implement secure web applications in this model, the server programs need some special primitives for manipulating security concepts and constructs. For example, special tokens (e.g., SID) can be used to identify users and logical transactions, and those tokens can be embedded in the cookies and forms on the client side.

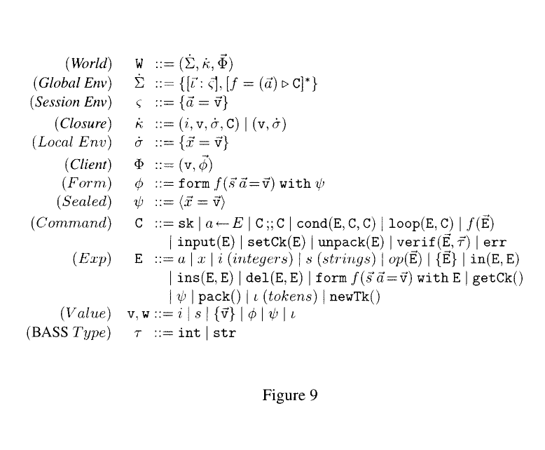

The following discussion presents the details of this model as a low-level language MOSS. For conciseness, MOSS is left untyped, but it is straightforward to give it a standard typing. The MOSS syntax is given in FIG. 9. The vector notation (e.g., \vec{Φ}) is used at times when referring to a list of items (e.g., [Φ₁ . . . Φₙ]). Some symbols for referring to certain language constructs are borrowed from BASS to show the correspondence of the underlying concepts, but minor modifications are applied to avoid confusion. In particular, a different font is used for reused English letters (W, C, E and v), and a dot is added on top for reused Greek letters (

$$\dot{Σ} ,$$

\dot{κ}, and \dot{σ}).

In one embodiment, a world W in this language consists of three elements. The first is the global environment

$$\dot{Σ}$$

on the server. The second is a closure \dot{κ} currently active on the server. The third is a list of browsing histories \vec{Φ}, each belonging to a different client.

The global environment

$$\dot{Σ}$$

contains both data and code. The data part is essentially a list of session environments ζ organized by some tokens ι for identifying sessions (i.e., SIDs). Every session environment ζ captures the values of the volatile variables (e.g., a,a′,a₁) for a session. The code part is simply a collection of functions, with every function consisting of a name ƒ, a list of input parameters \vec{a}, and a body command C. Here, the symbols [ ] are used as parentheses of the meta language, rather than as part of MOSS.

The closure \dot{κ} is usually a tuple consisting of a client identifier i (indicating that the current computation is for the ith client; this corresponds to the transient but dedicated connection established between the client and the server for an HTTP request-response), a value v as the content of the cookie (transferred from the client to the server in a request and passed back to the client in a response), a local environment \dot{σ}, and a command C. Sometimes a pair of a cookie value and a local environment also makes a closure; such a closure cannot be executed, but the information therein may be propagated to other closures. The local environment \dot{σ} simply collects the values of non-volatile variables (e.g., x,x′,x₁). It is assumed that \dot{σ} contains a special variable x_{sid} dedicated for storing the SID of the underlying session. Alternatively, one may wish to store the SID in the cookie. Since the cookie is shared by all forms on a client, that would prevent the same client from accessing multiple sessions simultaneously. Therefore, in the following discussion, the SID is stored in the local environments of the individual “threads.”

The clients vector \vec{Φ} deserves attention. In BASS, the single client is idealized as a list of closures. In MOSS, a world involves multiple clients, each consisting of a cookie with the value v and a list of forms \vec{φ}. A form φ is made up of input parameters \vec{a} and their textual explanations \vec{s} and default values \vec{v} (i.e., input fields in a web form), a target ƒ (i.e., the web link behind the “submit” button), and some sealed client-side state ψ. Note that in one embodiment ψ is not meant to be modified by the client. This restriction will be enforced in the operational semantics. In the syntax, the notation [symbol] . . . [symbol] is used to indicate that it is a “package” that cannot be taken apart by the client. In a real language, such sealed state can be encrypted/signed by the server to prevent client modifications. The forms in a client may belong to different sessions, because the client may initiate different sessions in different browser windows. Although reserving a dedicated variable x_{sid} in the local environments for session identification, MOSS does not automatically maintain it (or any other non-volatile variables) across web interactions. As is the case of real web programming, the programmer may maintain the relevant information in the sealed state.

Commands C involve both common ones and new primitives. All the new primitives are adapted from real-world entities for secure server-side scripting. For distinction from BASS, a different syntax is used for the common commands of skip (sk), assignment (a←E), sequential composition (C;;C), conditional (cond(E,C,C)), and while-loop (loop(E,C)). ƒ(\vec{E}) is a function call to ƒ with the arguments \vec{E}. When the server program needs web input, input(E) is used to send a form computed from E to the client. setCk(E) sets a new value for the cookie in the current closure. unpack(E) unpacks the sealed state from E. verif(\vec{E},\vec{τ}) validates \vec{E} against BASS types \vec{τ}. Finally, err exits the program upon an error; this abrupt program termination is used for simplicity, although real web applications typically perform more sophisticated error handlings (e.g., giving error messages, redirecting to other pages). The exact meanings of these commands will be defined by the operational semantics.

MOSS reuses the variables a and x, integers i, strings s, and abstract operations op(\vec{E}) of BASS for ease of exposition of the translation discussed below. It also introduces some set expressions: {\vec{E}} is a set with elements \vec{E}, in(E,E′) checks if E belongs to the set E′, ins(E,E′) inserts E into the set E′, and del(E,E′) removes E from the set E′. form constructs a form by putting together some input parameters, a target function, and an expression carrying the sealed state. getCk( ) obtains the cookie value. ψ is a sealed state, and it is typically created using pack( ). Finally, tokens ι are unique and unforgeable entities created using newTk( ); in one embodiment, newTk( ) will never create two identical tokens, and the tokens created cannot be guessed/forged by clients. The exact form of tokens is abstract in MOSS. We have already mentioned the use of tokens as SIDs. Later when translating BASS, tokens are also used to identify clients, enforce control flows and prevent request forgeries.

### Operational Semantics

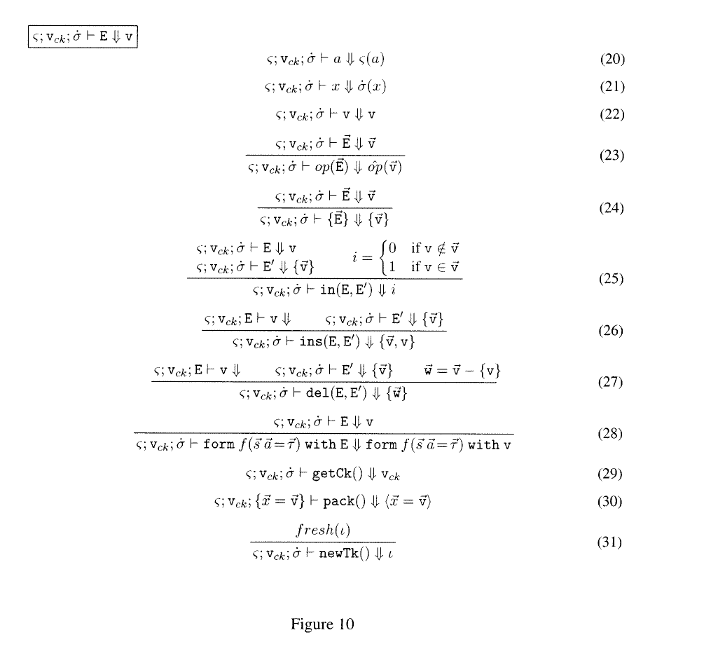

FIG. 10 illustrates one embodiment of the semantics of expressions for MOSS expression evaluation. The evaluation is carried out with respect to three entities: a session environment ζ, a cookie value v_{ck}, and a local environment \dot{σ}. The values for volatile and nonvolatile variables are pulled from their environments respectively in Rules (20) and (21). Values require no further evaluation (Rule (22)). In Rule (23), the notation

$$\hat{op}$$

refers to the corresponding meta-level computation of op. The set expressions are evaluated as expected in Rules (24)-(27), where integers are used to simulate booleans. Rule (28) evaluates the expression component of a form, which is expected to be a sealed state, and composes a form value. Rule (29) simply provides the cookie as the result of evaluating getCk( ). Rule (30) creates a sealed state based on the local environment. Finally, Rule (31) produces a fresh token.

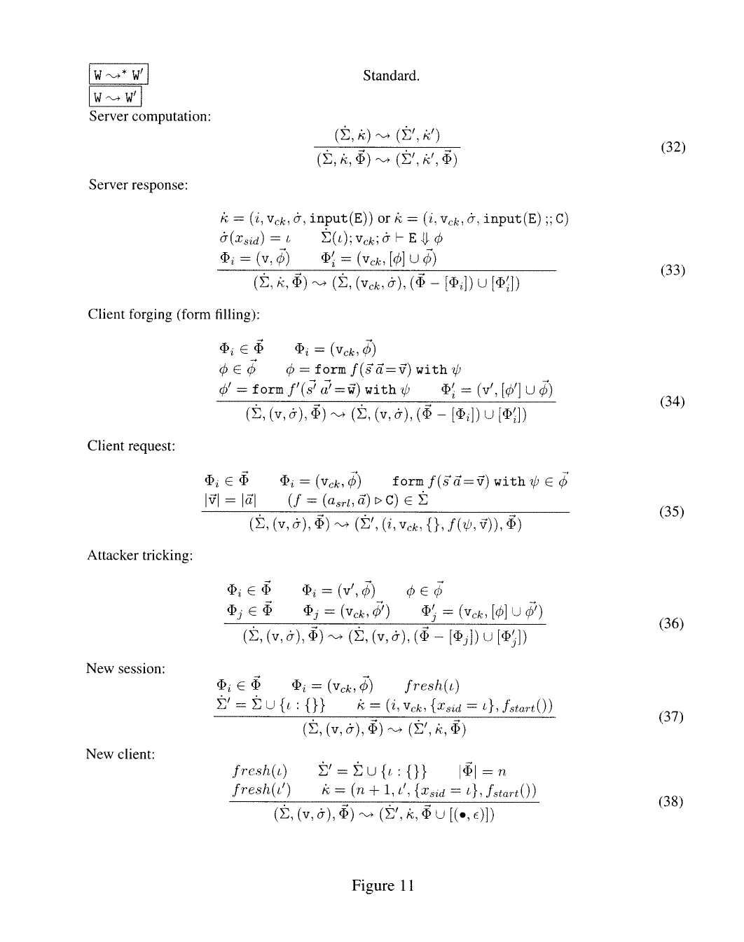

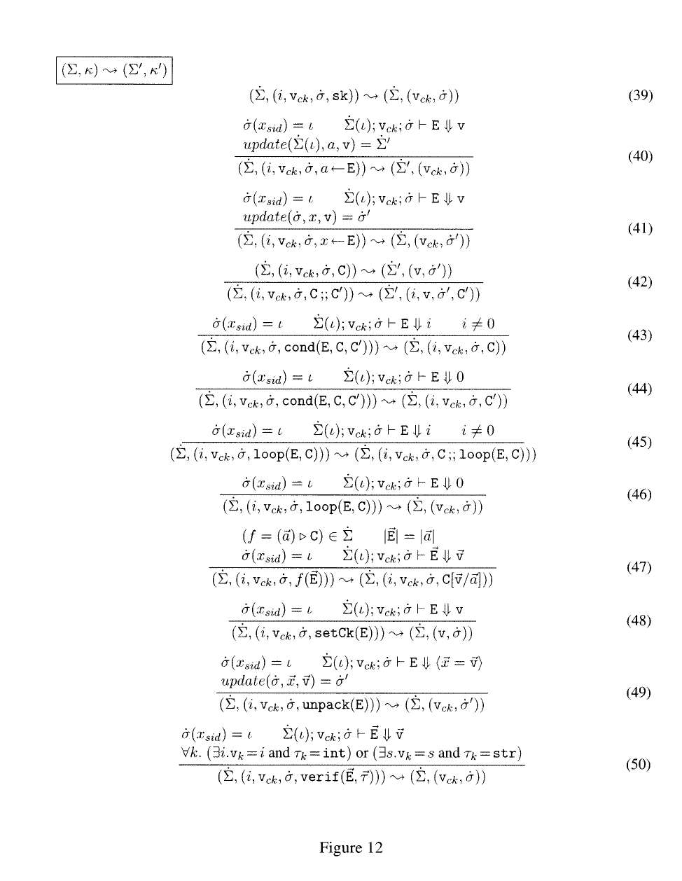

The remainder of the operational semantics is given in FIGS. 11 and 12. Similar to BASS, one concept is a “world step” relation W [symbol] W′. A multi-step relation W [symbol] W′ is defined as the reflexive and transitive closure of the world step relation.

Most of the server-side computation is captured in Rule (32), which delegates the task to a single-thread step relation

$$( \dot{Σ} , \dot{κ} ) ( {\dot{Σ}}^{′} , {\dot{κ}}^{′} ) .$$

Upon an input(E) command (Rule (33)), the expression E is evaluated to a form φ, and the result is transferred to the client. Note that the special variable x_{sid} is used to obtain the SID ι, and ι is used to locate the session environment (we use

$$\dot{Σ} ( ι )$$

to refer to the session environment identified by ι in

$$\dot{Σ}$$

In addition, the client identifier i is used to locate the client history Φᵢ. Φᵢ may contain a different cookie value v, because the server may have updated the cookie to v_{ck} in the current closure \dot{κ}. The client history is updated from Φᵢ to Φᵢ′ using the new cookie v_{ck} and form φ. In the result of the step, the clients vector is updated by removing the old Φᵢ and inserting the updated Φᵢ′. Any command C following input(E) is unreachable and thus discarded. This reflects the case that the server execution stops after sending a response to the client, and resumes after receiving the next request; the control flow is connected by a link embedded in the web form E, not by sequencing with another command C. This Rule (33) is the only one that describes the execution upon an input(E) command. Therefore, the execution of a MOSS program gets stuck if E is not a form, if ι is not recognized by

$$\dot{Σ} ,$$

or if x_{sid} does not contain a valid token at all. Similar observations apply to other rules.

The remainder rules of the world step relation concern things initiated from the client side. An ideal case is that a client may fill in a form with arbitrary values. However, in the real-world handling of a web form, the target function name and input fields are subject to malicious modifications, because they are directly embedded behind the “submit” button so that the browser can recognize them and produce an HTTP request. Such a scenario is captured in Rule (34), where a client Φᵢ forges a new form φ′ (the ideal form filling is simply a special case of this). In one embodiment, the client may make up arbitrary things on the function name and input fields. However, the sealed state ψ cannot be made up arbitrarily (e.g., the client cannot forge the server's signature); it must come from some other form φ in the history of Φᵢ. In addition, the cookie value may also be modified by the client from v_{ck} to v′. As a result of the transition, the new client Φᵢ′ includes the forged form φ′ and cookie v′, and the clients vector \vec{Φ} is updated accordingly. The server side remains unchanged.

In Rule (35), the ith client picks an arbitrary form from the history, selects a proper number of input values (|\vec{v}|=|\vec{a}| means that the two vectors have the same length), and submits the form. On the server side, the function ƒ is recognized by the global environment, and the function expects the proper number of arguments (aₛᵣₗ is a special argument for the sealed state). In the result of the step, a new closure is composed for execution, where the cookie is obtained from the client, and the function ƒ is applied to the sealed state and the input values. Note that no input validation on the argument types is done in this rule. Therefore, a program which does not perform proper input validation on its own may get stuck in later computation.

Sometimes an attacker tricks a victim into sending a request composed by the attacker. In Rule (36), the attacker client i picks an arbitrary form φfrom Φᵢ, and inserts it into the victim client j's history. The server side remains unchanged. Now that the form is injected into the victim client, a later request following Rule (35) may submit it to the server, thus completing the attack.

An existing client may initiate a new session using Rule (37). On the server side, a fresh token ι is created as the SID, an empty session environment is added into the global environment

$$\dot{Σ} ,$$

and a new closure \dot{κ} is composed. In the closure \dot{κ}, the local environment is initiated so that x_{sid} is bound to ι, and the code starts from ƒₛₜₐᵣₜ, which is a special function reserved as the entry point of MOSS programs. The session environment and the local environment do not contain entries for programmer-defined variables yet. Instead, those variables will be declared implicitly upon their first use, which is articulated in later rules for executing assignments.

The last client-initiated transition, Rule (38), applies when a new client joins the interaction. Similar to Rule (37), a new session with SID ι is created. In addition, another fresh special token ι′ is created as an ID for uniquely identifying the client (referred to herein as the “CID”). ι′ is stored in the cookie of the new closure \dot{κ}, and will be propagated to the client upon further web interactions using Rule (33). As a result of the transition, the global environment is updated, the new closure is activated for execution, and the clients vector is updated to include the new client, which has the transient client identifier n+1, an empty cookie indicated by the special value •, and an empty history vector ε.

FIG. 12 defines the single-thread step relation

$$( \dot{Σ} , \dot{κ} ) ( {\dot{Σ}}^{′} , {\dot{κ}}^{′} ) .$$

The cases for skip (Rule (39)), sequencing (Rule (42)), conditional (Rules (43) and (44)), and while-loop (Rules (45) and (46)) are standard. Assignments are defined in Rules (40) and (41), where a macro update is overloaded to update both session environments ζ and local environments \dot{σ}. If the variable to be updated is not in the environment, the macro will create a new entry, thus the variable is implicitly declared upon first use.

Rule (47) carries out a function call using capture-avoiding substitution, after checking the number of and evaluating the arguments. Rule (48) updates the cookie of the current closure. Rule (49) evaluates E to a sealed state, and updates the local environment \dot{σ} accordingly. Finally, Rule (50) validates \vec{E} against BASS types \vec{τ}. There is no rule for the case where the validation fails—the execution gets stuck upon a failed validation.

### EXAMPLE

MOSS is a very flexible language, and some syntactically correct programs could result in stucks during execution. The causes of such a stuck include unrecognized SIDs or function names, unmatched number of function parameters, illegal/ill-typed usage of values (e.g., unpacking an integer), and failed input validations. Indeed, MOSS is meant to reflect real-world web application scenarios, rather than to confine web program behaviors using a restricted semantics or a type system. Similar to the case of existing web programming languages, MOSS can be used to write secure web programs as well as vulnerable ones.

In the following, MOSS is used to illustrate a CSRF attack where an attacker B exploits a vulnerable banking application to process a payment request
φ=form ƒ_{pay}(“payee” p=“B”, “amnt” a=100) with [symbol]
   as if it was intended by a victim client A, while A is logged in. It is assumed that the application stores the SID in the client cookie.

$$( \dot{Σ} , ( {v}_{0} , {\dot{σ}}_{0} ) , [ ( {ι}_{A} , \vec{{φ}_{A}} ) , ( {ι}_{B} , \vec{{φ}_{B}} ) ] )$$

$$\begin{matrix} ( \dot{Σ} , ( {v}_{0} , {\dot{σ}}_{0} ) , [ ( {ι}_{A} , \vec{{φ}_{A}} ) , ( {ι}_{B} , \vec{{φ}_{B}} ⋃ [ φ ] ) ] ) & ( forge by Rule ( 34 ) ) \\ ( \dot{Σ} , ( {v}_{0} , {\dot{σ}}_{0} ) , [ ( {ι}_{A} , \vec{{φ}_{A}} ⋃ [ φ ] ) , ( {ι}_{B} , \vec{{φ}_{B}} ⋃ [ φ ] ) ] ) & ( trick by Rule ( 36 ) ) \\ ( \dot{Σ} , {\dot{κ}}_{pay} , [ ( {ι}_{A} , \vec{{φ}_{A}} ⋃ [ φ ] ) , ( {ι}_{B} , \vec{{φ}_{B}} ⋃ [ φ ] ) ] ) & ( request by Rule ( 35 ) )\end{matrix}$$

In the above, the attacker B forges the form φ in the first step, and injects it into A (e.g., by emailing a link) in the second step. When A submits the form (e.g., by following the link) in the third step, the server program identifies the session based on the SID ι_{A} in A's cookie, and recognizes that the request is from A. Therefore, a closure \dot{κ}_{pay} is composed to set up a payment from A.

Similarly, MOSS can be used to illustrate many other attack scenarios, including first-order XSS, session fixation, session poisoning, ill-typed input, and work-flow circumvention. In contrast, none of these attacks may happen in BASS according to its meta properties. The following discusses how the BASS semantics can be enforced.

### Translation

BASS programs are translated into MOSS following secure coding practices to enforce the semantics of BASS. BASS has an ideal model where the control flow is not disrupted by web input, there is only a single session, and the client is well-behaved. These no longer hold in the MOSS model of real-world scenarios. To connect the two models, the translation takes care of program splitting, form making, session management, state maintenance, forgery prevention, and input validation. Recall from FIGS. 8 and 9 that a client in MOSS consists of a cookie and a list of forms. In the translation herein, an invariant is maintained that the cookie stores the CID of the client, and the forms are of the following shape:
form ƒ(\vec{s}\vec{a}=\vec{w})
   with [symbol] x_{cid}=ι_{cid},x_{sid}=ι_{sid},xₜₒₖ=ιₜₒₖ,x_{ƒun}=s_{ƒ},\vec{x}=\vec{v}

[symbol]

This is essentially an encoding of the client closures of BASS in the client forms of MOSS, which is a key to the translation. Besides the target function ƒ and input parameters \vec{a}, we also encode information about the local environment (non-volatile variables \vec{x}=\vec{v}). In addition, some special variables are used for session management and forgery prevention.

The first special variable, x_{cid}, stores the CID that the server program assigned for the client in Rule (38). In a translated program, before sending a response to the client, the CID is obtained from the cookie in the current closure, and put into the variable x_{cid}. On the other hand, when processing a request from a client, x_{cid} is inspected and checked against the client cookie. This ensures that the request indeed comes from the client, based on some simple observations: (1) the sealed state cannot be modified by a client, (2) the cookie of a client cannot be updated by others, (3) although a client may modify her cookie, she cannot change it to the value of another client's CID, because CID is unforgeable. These together prevent attacker-crafted forms, inserted into a victim's history following Rule (36), from being accepted by the server.

The x_{sid} variable is dedicated for storing the SID. The xₜₒₖ variable stores a server generated token for “history control.” The validity of this token will be checked when the server program processes the request. For single-use forms, the token will be invalidated after the first use, thus preventing future resubmissions from being accepted. Furthermore, the token can be invalidated by the server program if the programmer chooses to disallow all existing forms (following the behavior of a BASS clear operation). As discussed above, more sophisticated history control is easily conceivable, but the simple clear is used for demonstration. We also point out that values in x_{sid} and xₜₒₖ only need to be unique; they do not have to be unforgeable on their own, because they are stored in the sealed state and thus cannot be forged. The same token construct is reused for CID, SID, and history control in MOSS, but this is not a request for the present invention.

Besides the three tokens, there is a special variable x_{ƒun} that stores the target function name. This is to prevent certain request forgeries where the client modifies the target function of the form. Upon a request, x_{ƒun} will be inspected and the request will be processed only if it matches the actual target function.

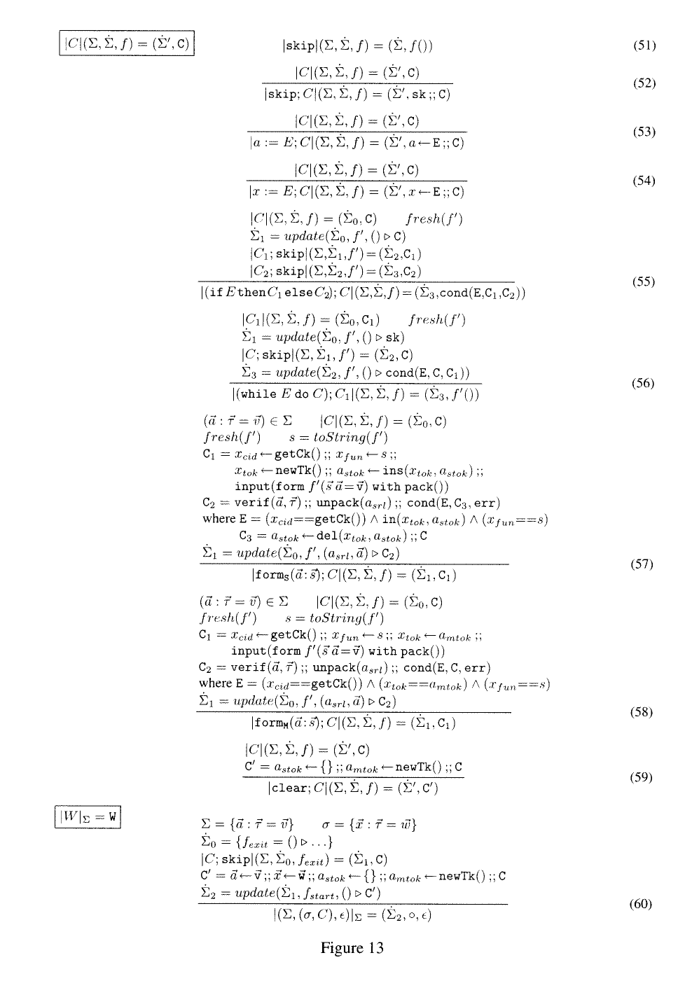

In one embodiment, the exact translation is given in FIG. 13. In one embodiment, since all BASS expressions/values are MOSS expressions/values, the expression translation is trivial. In the translation rules, the font is adjusted, updating E to E to indicate the trivial translation from a BASS expression E to the corresponding MOSS expression E.

Command translation has the form

$$\vert C \vert ( Σ , \dot{Σ} , f ) = ( {\dot{Σ}}^{′} , C ) .$$

Here the BASS command C is translated into the MOSS command C. The translation takes as input a BASS global environment Σ, a MOSS global environment

$$\dot{Σ} ,$$

and a function name ƒ. Σ is propagated throughout the translation without change; it is used to obtain the types of input variables when producing code for input validation.

$$\dot{Σ}$$

is an environment to be updated to

$${\dot{Σ}}^{′} ,$$

so that new code blocks introduced during program splitting can be accumulated. ƒ is provided as a continuation to the current command.

Rule (51) describes the base case of translating a skip. The translation produces the same environment

$$\dot{Σ}$$

and a call to the continuation ƒ. All other rules translate compound commands.

Rules (52), (53) and (54) translate compound commands which start with a skip or assignment. These commands are translated into their counterparts in MOSS. Note that the environment

$$\dot{Σ}$$

may be updated to

$${\dot{Σ}}^{′}$$

when translating the tail command C.

Rule (55) translates a compound command starting with a conditional. First the tail C is translated into C, producing the environment

$${\dot{Σ}}_{0} .$$

Next, a fresh label ƒ′ is created and is added into

$${\dot{Σ}}_{0}$$

to refer to C. The updated environment

$${\dot{Σ}}_{1}$$

is then used to translate the two branches C₁ and C₂ (skip is inserted so that the command translation needs only one base case—Rule (51)), with the new label ƒ′ as the continuation for both. Finally, the translation result is produced using the latest environment

$${\dot{Σ}}_{3}$$

and a corresponding MOSS conditional. In this rule, the new label ƒ′ is created to restructure the control flow in case either conditional branch involves web input. Suppose C₁ is of the form a:=1; form_{S}( . . . ); a:=2. Rule (55) would produce split target code—C₁ would only be a←1;;input(φ), and the link embedded in φ would point to a function with the code a←2;;ƒ′( ). If neither branch involves web input, an optimized version can be used to produce simpler target code, which is straightforward and omitted.

Rule (56) translates while-loop. A fresh label ƒ′ is created as the entry point of the loop. Some dummy code for ƒ′ is inserted into

$${\dot{Σ}}_{0} ,$$

yielding

$${\dot{Σ}}_{1} . {\dot{Σ}}_{1}$$

is then used to translate C (appended with skip) with ƒ′ as the continuation. Finally, the code of ƒ′ is updated with a conditional in the final environment

$${\dot{Σ}}_{3} .$$

If the expression E evaluates to true, C will be executed; a loop is formed because C uses ƒ′ as the continuation. If E evaluates to false, C₁ (translated from C₁) will be executed, thus exiting the loop. Again, an optimized version can be used if C does not involve web input.

The translation of web input follows the intuition and form encoding described at the beginning of this section. Rule (57) translates a single-use form form_{S}(\vec{a}:\vec{s}) followed by a command C. The program will be split into two parts here. Whereas the first part C₁ will be explicit in the translation result, the second part C₂ will be stored in the result environment

$${\dot{Σ}}_{1}$$

under a fresh label ƒ′. In C₁, we put the cookie value (the CID) into x_{cid}, put the function name s into x_{ƒun} (toString(ƒ′) converts function names to unique strings), put a fresh token into xₜₒₖ, update a volatile variable aₛₜₒₖ to include the new token in the set of valid tokens, and send out a form with ƒ′ as the target, some default values \vec{v} obtained from the initial environment Σ (this decision is arbitrary, and other default values can be used), and the sealed state created using pack( ). In C₂, which will be executed when the form is submitted, the input parameters are validated by type, the sealed state is unpacked, and the validity of the request is checked using E. In E, the CID in x_{cid} is compared against the cookie to detect attacker injected forms, the validity of the token xₜₒₖ is checked to prevent the single-use form being submitted a second time, and the target name x_{ƒun} is checked to prevent forged links. Suppose all these checks succeed, the used token xₜₒₖ is removed from the list of valid tokens aₛₜₒₖ, and the program proceeds with the command C translated from C. Otherwise, the program is terminated with err.

Rule (58) translates a multi-use form form_{M}(\vec{a}:\vec{s}) followed by a command C. The idea is similar to Rule (57), except that the same token stored in aₘₜₒₖ is reused for all multi-use forms (aₘₜₒₖ will be initialized somewhere else). In command C₂, after the validation and unpacking, a check is made as to whether the token xₜₒₖ still matches aₘₜₒₖ (aₘₜₒₖ will be given a new value if the server program chooses to disable all client forms using clear).

The last command translation case is described in Rule (59). Upon a clear, the volatile variables aₛₜₒₖ and aₘₜₒₖ are reset. This effectively disables all existing forms on the client, because the form translations in Rules (57) and (58) check the validity of the embedded tokens against aₛₜₒₖ and aₘₜₒₖ.

With the command translation defined, the translation of a complete BASS world is presented in Rule (60). Here, only those that correspond to an unexecuted program are translated, where the client history is empty. The translation refers to two special labels: ƒₛₜₐᵣₜ as the entry point of the program, and ƒₑₓᵢₜ as the exit point. The program body C (appended with a skip) is translated with ƒₑₓᵢₜ as the continuation, and an entry for ƒₛₜₐᵣₜ is created in the final environment

$${\dot{Σ}}_{2} .$$

The body of ƒₛₜₐᵣₜ initializes the session environment and local environment based on the BASS environments

$$\dot{Σ}$$

and \dot{σ} and assigns initial values to aₛₜₒₖ and aₘₜₒₖ.

### Correctness and Prototyping

This concludes the formal translation, where the high-level semantics of BASS is enforced using careful manipulations of tokens and sealed states in MOSS. Note that a BASS program corresponds to a single session in MOSS. With the translation (a compiler) taking care of the common manipulations on web interactions and security once and for all, programs can be written in BASS following a simple and elegant declarative view of web programming. The correctness of the translation has been discussed informally throughout the section. In principle, it is possible to formally prove the correctness of the translation, because the underlying BASS and MOSS both have rigorous semantics.

Another correctness argument is on the preservation of all the properties discussed herein. This can be easily established by inspecting the form encoding presented earlier. Since the sealed state is protected, the only form component subject to client modification is the input parameters. Modifications on the target function name will not succeed, because the function name is also stored in the sealed state. As a result, the control flow of a BASS program will be enforced, since clients cannot forge target links—they can only follow the server-provided forms to access the server programs. In addition, an attacker cannot masquerade as another client—although an attacker may modify the cookie, she cannot set it to the unforgeable CID of another client. More interestingly, CSRF, first-order XSS and session fixation, which require an attacker to inject forms into a client (Rule (36)), are prevented because the injected forms will have a different CID than stored in the client's cookie. Finally, input validation, session state recovery, and history control are all properly carried out.

### An Example of a Computer System

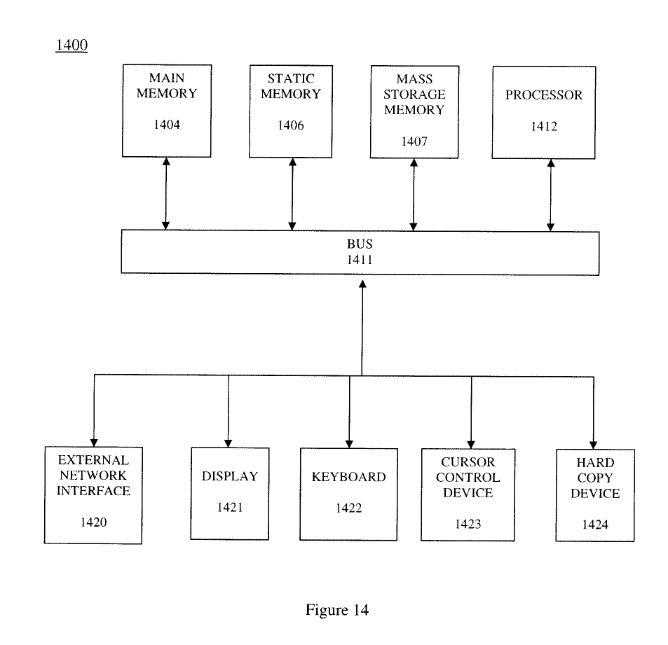

FIG. 14 is a block diagram of an exemplary computer system that may perform one or more of the operations described herein. Referring to FIG. 14, computer system 1400 may comprise an exemplary client or server computer system. Computer system 1400 comprises a communication mechanism or bus 1411 for communicating information, and a processor 1412 coupled with bus 1411 for processing information. Processor 1412 includes a microprocessor, but is not limited to a microprocessor, such as, for example, Pentium™, PowerPC™, Alpha™, etc.

System 1400 further comprises a random access memory (RAM), or other dynamic storage device 1404 (referred to as main memory) coupled to bus 1411 for storing information and instructions to be executed by processor 1412. Main memory 1404 also may be used for storing temporary variables or other intermediate information during execution of instructions by processor 1412.

Computer system 1400 also comprises a read only memory (ROM) and/or other static storage device 1406 coupled to bus 1411 for storing static information and instructions for processor 1412, and a data storage device 1407, such as a magnetic disk or optical disk and its corresponding disk drive. Data storage device 1407 is coupled to bus 1411 for storing information and instructions.

Computer system 1400 may further be coupled to a display device 1421, such as a cathode ray tube (CRT) or liquid crystal display (LCD), coupled to bus 1411 for displaying information to a computer user. An alphanumeric input device 1422, including alphanumeric and other keys, may also be coupled to bus 1411 for communicating information and command selections to processor 1412. An additional user input device is cursor control 1423, such as a mouse, trackball, trackpad, stylus, or cursor direction keys, coupled to bus 1411 for communicating direction information and command selections to processor 1412, and for controlling cursor movement on display 1421.

Another device that may be coupled to bus 1411 is hard copy device 1424, which may be used for marking information on a medium such as paper, film, or similar types of media. Another device that may be coupled to bus 1411 is an external network interface 1420 to communication to a phone or handheld palm device.

Note that any or all of the components of system 1400 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method comprising:
creating a server-side program with one or more abstractions; and
compiling the server-side program by translating the server side program, including the one or more abstractions, into target code that is guaranteed to execute in a secure manner with respect to a security criteria.

2. The method defined in claim 1 wherein the translated abstractions ensure that values obtained from web input will be well typed.

3. The method defined in claim 1 wherein the translated abstractions ensure that program states will be kept intact across web interactions.

4. The method defined in claim 1 wherein the translated abstractions cause the target code to not accept entries in the client history for processing in future computation when the target code performs a corresponding command on history control.

5. The method defined in claim 1 wherein the translated abstractions cause a program instance of the target code allows only one client to access and affect state of the program instance.

6. The method defined in claim 1 wherein the one or more abstractions comprise at least one domain-specific abstraction.

7. The method defined in claim 1 wherein the one or more abstractions comprise one or more abstractions from a group consisting of a web input abstraction, a session management abstraction, a state maintenance abstraction, a history control abstraction, and an exploit prevention abstraction.

8. The method defined in claim 7 wherein the web input abstraction comprises a form construct that implicitly opens a service interface for receiving user requests.

9. The method defined in claim 8 wherein the form construct specifies a single-use mode in which the service interface is open only once before an error is generated or a multi-use mode in which the service interface remains open for future requests.

10. The method defined in claim 8 wherein the form construct takes an HTML document as an argument.

11. The method defined in claim 8 wherein the form construct presents an HTML page to a client and obtains input from the client in response thereto.

12. The method defined in claim 7 wherein the one or more abstractions comprise a history control command to cause a portion of a client state to be removed.

13. The method defined in claim 12 wherein the client state comprises client history.

14. The method defined in claim 1 wherein the server-side program is a web program and the one or more abstractions comprise a set of abstractions on web input, session management, state maintenance, history control, and exploit prevention.

15. The method defined in claim 1 wherein the one or more abstractions comprise at least one script.

16. The method defined in claim 1 wherein creating a server-side program comprises inserting the one or more abstractions in a preexisting server program.

17. The method defined in claim 1 wherein compiling the server-side program comprises inserting security checks to enforce the security criteria during compilation.

18. The method defined in claim 1 wherein the server-side program comprises a web program.

19. The method defined in claim 1 wherein compiling the server-side program comprises adding one or more primitives to cause one or more client-side states to be removed.

20. An article of manufacture having one or more computer-readable storage medium storing instructions, which when executed by a system, cause the system to perform a method comprising:
creating a server-side program with one or more abstractions; and
compiling the server-side program by translating the server-side program, including the one or more abstractions, into target code that is guaranteed to execute in a secure manner with respect to a security criteria.

21. The article of manufacture defined in claim 20 wherein the one or more abstractions comprise at least one domain-specific abstraction.

22. The article of manufacture defined in claim 20 wherein the one or more abstractions comprise one or more abstractions from a group consisting of a web input abstraction, a session management abstraction, a state maintenance abstraction, a history control abstraction, and an exploit prevention abstraction.

23. The article of manufacture defined in claim 20 wherein the server-side program comprises a web program.

24. The article of manufacture defined in claim 20 wherein compiling the server-side program comprises adding one or more primitives to cause one or more client side states to be removed.

25. The article of manufacture defined in claim 20 wherein the translated abstractions ensure that values obtained from web input will be well typed.

26. The article of manufacture defined in claim 20 wherein the translated abstractions ensure that program states will be kept intact across web interactions.

27. The article of manufacture defined in claim 20 wherein the translated abstractions cause the target code to not accept entries in the client history for processing in future computation when the target code performs a corresponding command on history control.

28. The article of manufacture defined in claim 20 wherein the translated abstractions cause a program instance of the target code allows only one client to access and affect state of the program instance.
